(19) United States
(12) Patent Application Publication
(10) Pub. No.: US 2020/0386689 A1
(43) Pub. Date: Dec. 10, 2020

(54) AUTOMATED ANALYSIS SYSTEM UTILIZING REAGENT ADDITION

(71) Applicant: Custom Sensors & Technology, Fenton, MO (US)

(72) Inventors: Richard Nordman, St. Charles, MO (US); Mike Ponstingl, Sunset Hills, MO (US)

(21) Appl. No.: 16/927,772

(22) Filed: Jul. 13, 2020

Related U.S. Application Data
(63) Continuation-in-part of application No. 16/871,895, filed on May 11, 2020.
Application No. 16/871,895 is a continuation-in-part of application No. 15/974,450, filed on May 8, 2018.
Application No. 15/974,450 is a continuation-in-part of application No. 15/974,450, filed on May 8, 2018.
(60) Provisional application No. 62/873,498, filed on Jul. 12, 2019.
(60) Provisional application No. 62/845,950, filed on May 10, 2019.
(60) Provisional application No. 62/599,645, filed on Dec. 15, 2017.
(60) Provisional application No. 62/511,694, filed on May 26, 2017.
(60) Provisional application No. 62/503,144, filed on May 8, 2017.
(60) Provisional application No. 62/599,645, filed on Dec. 15, 2017.
(60) Provisional application No. 62/511,694, filed on May 26, 2017.
(60) Provisional application No. 62/503,144, filed on May 8, 2017.

(51) Int. Cl. G01N 21/85; G01N 21/77; B01F 5/00; G01N 35/10

(52) U.S. Cl. CPC G01N 21/8507; G01N 21/77; G01N 35/1004; G01N 35/1016; G01N 35/1011; B01F 5/008

(57) ABSTRACT

An automated system which can perform automated sample extraction from a process stream, automated addition of reagents or other materials to the sample, automated analysis on the sample, and then provide output on the results to process control equipment so that parameters of the processing could be altered in response to the testing. This can also allow for a more generally continuous measurement or at least a fast batch process which can be effectively endlessly repeated.

### CROSS-REFERENCE TO RELATED APPLICATIONS

This application claims the benefit of U.S. Provisional Patent Application Ser. No. 62/873,498, filed Jul. 12, 2019, the entire disclosure of which is herein incorporated by reference. This application is also a Continuation-In-Part (CIP) of U.S. Utility patent application Ser. No. 16/871,895, filed May 11, 2020, which claims the benefit of U.S. Provisional Patent Application Ser. No. 62/845,950 and is a Continuation-In-Part (CIP) of United States Utility patent application Ser. No. 15/974,450 filed May 8, 2018 which claims the benefit of U.S. Provisional Application Ser. No. 62/599,645, filed Dec. 15, 2017; 62/511,694, filed May 26, 2017; and 62/503,144, filed May 8, 2017. This application is also a Continuation-In-Part (CIP) of United States Utility patent application Ser. No. 15/974,450 filed May 8, 2018 which claims the benefit of U.S. Provisional Application Ser. No. 62/599,645, filed Dec. 15, 2017; 62/511,694, filed May 26, 2017; and 62/503,144, filed May 8, 2017. The entire disclosure of all the above documents is herein incorporated by reference.

### BACKGROUND OF THE INVENTION

### Field of the Invention

The invention relates to systems for automatically extracting and analyzing a liquid sample, generally from a process stream, where the analysis requires the addition of a liquid reagent prior to material testing, particularly photometric testing.

### Description of the Related Art

There are a number of places where production or activity creates what is effectively a process stream. Continuous manufacturing techniques as well as processes which are continuously acting on elements create a near constant output of end product. An example of this is water purification where an essentially continuous stream of source water is taken in and an essentially continuous output of cleaner water is generated. This type of essentially continuous process can be used, for example, where water needs to be treated prior to its use in a secondary process to provide process efficiency or in the treatment of wastewater streams.

Similarly, in manufacturing processes such as continuous distillation, it is necessary to essentially have a continuous feed of material fed to a distillation column to provide an essentially continuous feed of end product. This is used, for example in refining crude oil. It should be recognized that virtually any continuous (as opposed to a true batch) manufacturing process is designed to take in a stream of material and produce a stream of material so long as the process is operating. Still further, processes such as pollution control which operate on flue gas produced from combustion typically also must operate on continuous streams.

In these continuous processes, it should be recognized that monitoring of the process is important. Not all the wastewater or crude oil fed to the system has identical properties and depending on the nature of the input, the process may need to be slightly altered. For example, source water may be treated with chemicals to remove impurities such as silica, calcium or magnesium before it is fed to a boiler system to avoid buildup in the boiler. However, addition of two much or too little of these chemicals produces process inefficiency (such as by the economic waste of valuable chemicals, not removing a desired amount of the target, or by adding so much reagent that it creates a new problem) and the source water process stream will often not have constant or near constant contamination.

In order to determine what to add, it is generally the case that one either needs to monitor the source (e.g. to detect the amount of contaminant pretreatment) and/or to monitor the output to make sure that the resultant material is within desired parameters and suitable as an output. Should the end product not meet expectations, or changes in the input be detected, the processes can be altered (for example, temperatures can be lowered, residence times in various phases can be increased, or amounts of chemicals added can be increased or decreased) to provide for slightly different manufacturing parameters to make sure that the desired output is obtained.

While the underlying process may be continuous, this monitoring has previously not been continuous. While certain forms of monitors can provide near continuous measurement (for example certain forms of in situ optical sensors) these are not suitable for all forms of monitoring. In some types of tests, it is necessary to take a sample and perform remote and often destructive tests on the sample to determine the composition. If these types of test were performed truly continuously, there would essentially be no or substantially reduced output as much if not all the output would be consumed by the testing.

In these types of situations, testing is generally performed on a regular schedule with a small sample being removed from the stream and tested. Traditionally, sample removal and testing has been performed by hand. Specifically, a technician would go and obtain the sample, return it to the lab, perform the testing, and then determine the results. The problem with this system is that while it can verify that inputs or outputs are within target parameters, it generally does not allow for any correction as by the time the testing has been completed, the flow being tested has already moved on due to the testing process being very slow and the need for human labor. Thus, the testing was effective to verify that everything was working (essentially that the system was abiding by regulations or targets), but not useful to fix problems if it was not.

### SUMMARY OF THE INVENTION

The following summary of the invention is provided to give the reader a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented in a later section.

Because of these and other problems in the art, it would be desirable to have an automated system which can perform automated sample extraction from a process stream, automated addition of a reagent or similar material, automated analysis on the sample, and then provide output on the results to process control equipment so that parameters of the processing could be altered in response to the testing. This can also allow for a more generally continuous measurement or at least a fast batch process which can be effectively endlessly automatically repeated.

Described herein, among other things, is a testing system comprising: a rotary valve comprising a plurality of valve positions; a process stream having a sample collection apparatus therein, the sample collection apparatus being located at a first position in the plurality of valve positions; a measurement cell, the measurement cell being located at a second position in the plurality of valve positions; a motor, for rotating the rotary valve between the plurality of positions; a piston, for directing material through the rotary valve; and a sensor, for performing a measurement on a sample in the measurement cell.

In an embodiment of the testing system, the motor comprises a stepper motor.

In an embodiment of the testing system, the sensor comprises a photometer and associated light source.

In an embodiment, the testing system further comprises reagent in a reagent bottle connected to a third position in the plurality of valve positions.

In an embodiment of the testing system, the piston obtains the sample from the sample collection apparatus and then obtains the reagent from the reagent bottle before providing both the reagent and the sample to the measurement cell.

In an embodiment of the testing system, providing the reagent and the sample to the measurement cell mixes the reagent with the sample to form a mixture.

In an embodiment of the testing system, after the sensor performs the measurement on the mixture, the piston obtains the mixture from the measurement cell.

In an embodiment of the testing system, the piston exhausts the mixture to a waste collection vessel attached to a fourth position in the plurality of valve positions.

In an embodiment, the testing system further comprises a port for attaching a sample container at a third position in the plurality of positions.

In an embodiment, the testing system further comprises calibration fluid in a calibration fluid bottle at a third position in the plurality of positions.

In an embodiment, the testing system further comprises a cleaning fluid in a cleaning fluid bottle at a third position in the plurality of positions.

In an embodiment, the testing system further comprises multiple reagents, each of the reagents being in a separate reagent bottle connected to a separate position in the plurality of positions.

In an embodiment, the testing system further comprises a homing sensor for detecting when the rotary valve is at a specific position in the plurality of positions.

In an embodiment of the testing system, the specific position is the first position.

There is also described herein, in an embodiment, a method of performing automated testing, the method comprising: providing a testing system comprising: a rotary valve comprising a plurality of valve positions; a process stream having a sample collection apparatus therein, the sample collection apparatus being located at a first position in the plurality of valve positions; a measurement cell including an associated sensor, the measurement cell being located at a second position in the plurality of valve positions; and a reagent located at a third position in the plurality of valve positions; automatically rotating the rotary valve to the first position and obtaining a sample; automatically rotating the rotary valve to the third position and obtaining a reagent that is mixed with the sample to form a mixture; automatically rotating the rotary valve to the second position and exhausting the mixture to the measurement cell; using the sensor to perform a measurement on the mixture; returning the mixture from the measurement cell; and automatically rotating the rotary valve to a fourth position and disposing of the mixture.

In an embodiment of the method, the sensor comprises a photometer and associated light source.

In an embodiment of the method, the reagent and the sample are mixed via shear of drawing the reagent into the sample.

In an embodiment of the method, the mixture if further mixed by shear of exhausting the mixture to the measurement cell.

### BRIEF DESCRIPTION OF THE DRAWINGS

FIG. 1A shows an embodiment of an automated analysis system.

FIG. 1B shows the embodiment of FIG. 1A with the external housing removed so the functional internal components are visible.

FIG. 2A shows an embodiment of the selection subsystem.

FIG. 2B shows the embodiment of FIG. 2A with the external housing removed.

FIG. 3 shows an embodiment of the propulsion subsystem.

FIG. 4 shows an embodiment of the measurement subsystem.

FIG. 5 shows an embodiment of a display from the analysis system.

FIG. 6 provides a block diagram illustrating the positions of the selection subsystem and general operational principles.

### DETAILED DESCRIPTION OF PREFERRED EMBODIMENTS

Testing of process stream materials is particularly problematic where reagents or other materials need to be added to the test sample prior to testing. In some cases, for examples, solvents, marker dyes, precipitators, or other reagents need to be added to the test sample in particular ratios in order for the testing to be carried out. The more materials, which throughout this disclosure will be referred to generally as “reagents” which need to be added, typically the harder it has been to automate the process of testing. Still alternatively, it may be necessary to perform certain types of testing after a first reagent is added but before a second is added, or to add a first reagent to a portion of the sample and a second reagent to a different portion of the sample and perform two different tests or to compare a sample with the reagent against a control solution with the same reagent.

Processes can be further complicated if it is necessary to apply kinetic or similar action to the samples. For example, in some cases it may be necessary to add some reagents, agitate the sample or allow it to settle and then add others. Similarly, it may be necessary to apply heat or particular wavelengths of light for the measurement to be performed. One such area presenting a number of problems is in the performance of colorimetric analysis. Such analysis typically will require mixing of multiple reagents (including a marker for the analysis) and often requires the application of heat and light to the sample in order for the analysis to be performed in a reasonable time frame.

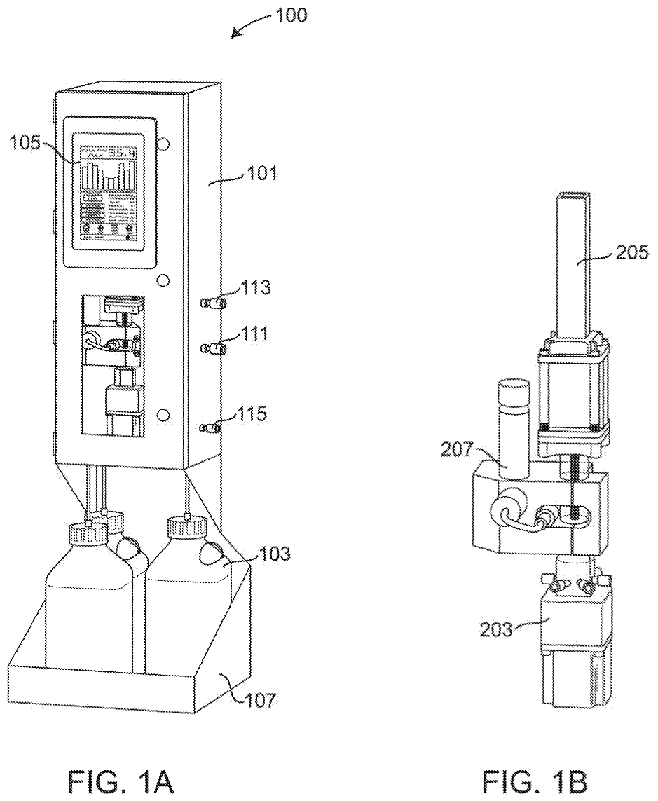

FIGS. 1A and 1B provide for an embodiment of an analysis system (100) which allows for automation of analysis, and specifically colorimetric analysis, on samples taken from a process stream on a continuous, or more accurately automated fast batch, process. FIG. 1A shows the primary mechanisms within an external housing (101) which is designed to provide for mounting space for additional components. This includes a screen (105) which generally comprises a touch screen or similar interface to allow for operation of the system (100). The housing (101) also includes a shelf (107) upon which are placed a variety of reagent storage vessels (103) in the form of bottles.

The housing (101) also includes a variety of ports for connection to external connections. This includes a sample inlet port (111) which will typically be used to provide access to a sample from the process stream, a sample outlet port (113) which may be used to send the sample to a user for remote testing or to obtain a sample provided by a human user into the system, and a waste port (115) which will typically allow disposal of the sample in an automated fashion.

The operational components of the embodiment of FIG. 1A are shown removed from the housing (101) in FIG. 1B. The structure of FIG. 1B comprises three main components: a sample and reagent selection system (203), a propulsion system (205) and a measurement system (207). The selection system (203) is typically designed to select the specific input material (whether sample, reagent, or other) to be provided to the measurement system (207) which performs the desired measurement. The propulsion system (205) serves to move fluid within the system (100) in order to perform additions, mixing, and expulsion of waste materials.

The system (100) generally automatically performs a liquid extraction in a process setting. As a simplified overview, first a known volume of sample will be obtained from a process stream (commonly via a fast loop connection) via the sample inlet port (111) which will be on fluid connection with the process stream. A number of reagents (103) will generally be automatically added serially to the sample in order to prepare it for analysis. The combined sample mixture will then be provided in a measurement cell (701) which can have additional action performed to allow for the measurement to be performed.

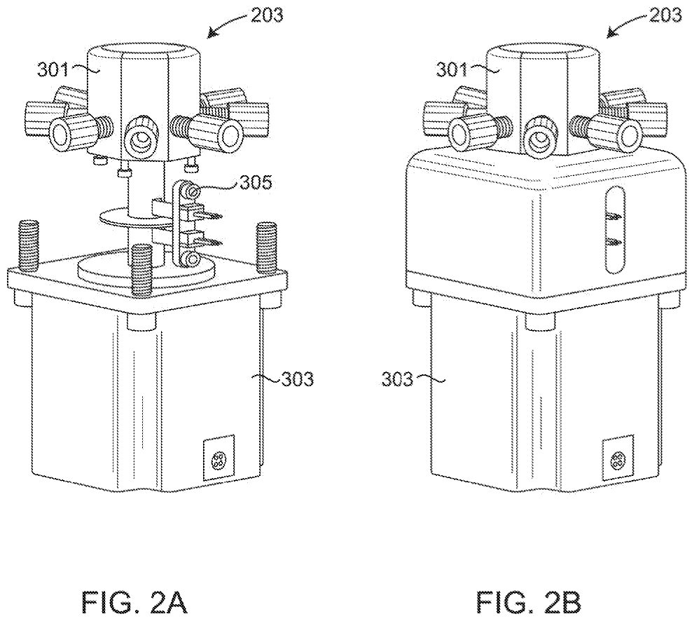

In order to carry out an analysis, the selection system (203) will generally comprise a multi-position rotary valve (301). The valve (301) is shown within a protective housing (300) in FIG. 2A and the housing (300) has been removed in FIG. 2B to show hidden elements. The number of valve openings in the valve (301) will generally be selected based on the number of different reagents which will needed to be used by the system and the number of other ports that are desired for the analysis or other features of the system (100).

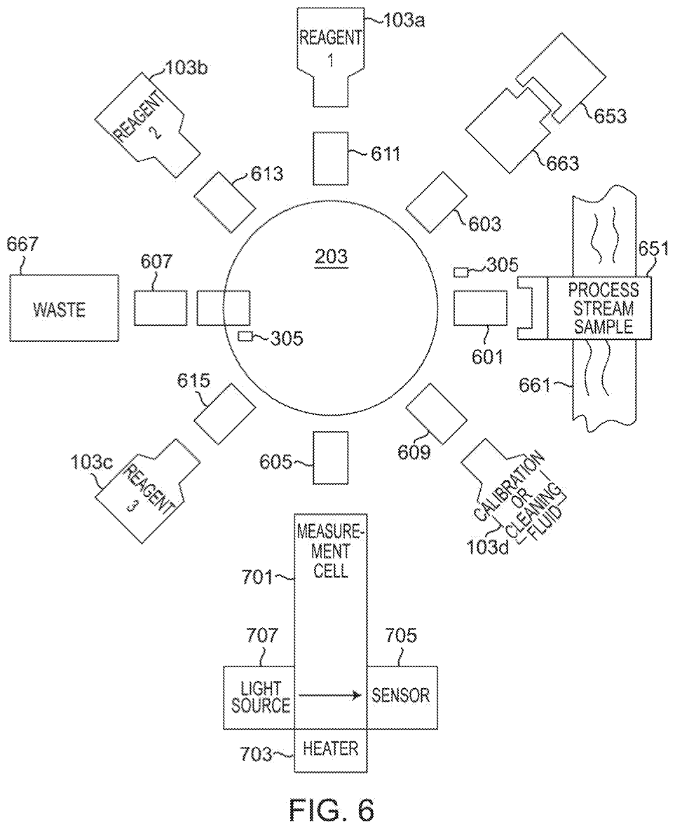

In the depicted embodiment of FIGS. 2A and 2B the selection system (203) comprises a rotary valve (301) and has 8 positions or openings. The positions are shown functionally in the Block Diagram of FIG. 6 as positions (601), (603), (605), (607), (609), (611), (613), and (615). Currently the selection system (203) is positioned to select the waste position (607) in FIG. 6, but the selection system (203) will be able to rotate the rotary valve (301) to the selected position of any of the positions (601), (603), (605), (607), (609), (611), (613), and (615) as needed. The selection system (203) will typically only be able to select from a single position to obtain material from at any one time, however, in an alternative embodiment it may be possible to select from multiple positions at once.

Examining FIG. 6, the first position (601) corresponds to a sample position for obtaining a sample (651) from the process stream (661). That is, this position (601) is connected to the process stream (661) via a sample collection device or to some other area that allows a sample (651) from the process stream (661) to be automatically obtained. The sample collection device may utilize any method, system, or means of sample collection and can be as simple as simply having hollow piping which extends into the process stream (661), to a capture chamber which can be open and closed within the process stream (661), to other structures and methods known to those of ordinary skill in the art for sampling from a process stream (661). In the depicted embodiment of FIGS. 1A and 1B, the sample inlet (111) will typically correspond to the position (601).

A second position (603) corresponds to a grab sample position (603) which can be used to provide a manual sample (653) or other material to the system (100) manually or to remove a sample from the system (100) for further testing or use. This valve position (603) will often be connected to a collection connector (663) or other similar type object which allows for the user to obtain a material or sample in a known container (653) (for example a test tube, pipette, or the like) and then simply connect or provide that container (653) to an interconnect (663) for such a container (653) at this position (603). The grab sample position (603), thus, allows for manual control of materials to be added to the selection system (203) providing a large amount of flexibility. The position (603) also allows for a sample (661) in the system (100) to be removed and captured. This allows for a sample which may have provided unexpected results to be saved for additional testing, or can be used to verify that the measurement cell (701) has been cleaned, for example. The position (603) will typically correspond to the output port (113) of FIGS. 1A and 1B.

There are three reagent positions for reagent 1 (611), reagent 2 (613), and reagent 3 (615). The reagents will typically be provided in bottles (103a), (103b), and (103c) to provide for specific reagent additions to the sample (651). Each will typically have its own bottle (103a), (103b), and (103c). There is also provided a calibration position (609) which may act as a bottle source for a calibration fluid (103d) for calibrating the system (100) or for cleaning fluid (103d) for cleaning the system (100). The calibration position (609) is generally the same type of position as a reagent positions (611), (613), or (615), but it is called out here as a separate position (609) to show how materials which are not specifically designed to be added to the sample (651) can also be utilized by the system (100).

The remaining positions in the embodiment of FIGS. 2A and 2B correspond to positions which are used for expelling or handling material(s) from the system (100) as opposed to adding them. The first of these is a measurement cell position (605) which is designed to connect with a measurement cell (701) where measurements on the sample (651) can take place. The propulsion system (205) will typically exhaust the sample and all mixed-in reagents to the measurement cell position (605) when it is time to take a measurement. The measurement cell position (605) may also be used for mixing. The last position (607) corresponds to a waste position. The waste position (607) will be used to expel the measured and modified sample to a waste container (667) after the measurement(s) have been completed and corresponds to the waste port (115).

It should be recognized that the inclusion of 8 positions in the selection system (203) of the FIGS is provided as a merely exemplary embodiment and in other embodiments more or less positions may be in the selection system (203) and valve (301). For example, in certain applications, a waste position (607) may not be needed as the waste can simply be expelled back into the process stream (661). Further, a number of reagents other than three may be desired. Positions related to the calibration positions (609) and grab sample positions (603) may also be eliminated if these functions are not required in the particular process measurements being performed. A position may also be provided that comprises an empty vessel which can be used to store a sample for a period of time while another is processed.

Returning to the embodiment shown in FIGS. 2A, 2B, and 6 the rotary valve (301) comprising the selection system (203) will generally be rotated by the means of a motor (303). The motor (303) preferably comprises a stepper motor as it provides for very accurate movement of the valve (301) and, thus, and precise orientation of the openings in a way that corresponds to the various positions (601), (603), (605), (607), (609), (611), (613), and (615) as discussed above. This insures that flow rates are consistent as the valve (301) does not unintentionally restrict flow such as from only being partially open to any specific position (601), (603), (605), (607), (609), (611), (613), or (615) or from possibly opening to multiple positions simultaneously.

As the determination of the amount of material sent into the measurement cell (701) will typically be determined by operation of the propulsion system (205) as opposed to a literal measurement, this helps insure that an expected amount of all materials is placed in the measurement cell (701) at the expected time. Further, ensuring that the various valve positions (601), (603), (605), (607), (609), (611), (613), and (615) are correctly aligned also helps to insure that the correct amount of each and every reagent (103a), (103b), and (103c) is added correctly.

In order to further improve accuracy, the selection system (203) will also typically include a homing sensor (305) such as, but not limited to, an optical sensor that can be used to home the rotary valve (301). The home position will typically correspond to the sample position (601) as shown in FIG. 6, but this is by no means required. The homing sensor (305) allows for re-calibration of the valve (301) positioning whenever desired to further insure that the valve (301) is correctly positioned regardless of position. Further, by positioning the homing sensor at the sample position (601), which is commonly the most used position in operation, it can allow for a homing action or check to occur during each testing operation as the homing position can be verified immediately before taking in the sample (651).

The rotary valve (301) will generally be connected to materials which are to be provided to the system (100). As discussed above, the first of these sources will typically be the process stream (661) and will provide the sample (651) for testing. The sample (651) may actually be provided via two different valves to provide for slightly different operations. These are indicated as the sample position (601) and the grab sample position (603). The sample position (601) will generally conform to a valve to provide a sample directly from the connected process stream (661) via a sample collection device to the system (100).

As the sample collection device is generally not manually accessible, the grab sample position (603) is designed to provide access to a manually provided sample or other external source. Thus, the grab sample position (603) will typically be connected to an input port (663) or (113) which can be used by a user who provides a sample or other material that they wish the system (100) to use for a generally single instance and via manual provision. For example, the grab sample position (603) may be connected to a port (663) or (113) which is designed to be interconnected to a sample collection tube (653) or similar object. It may also comprise a pipe or hose which can simply be placed in the relevant sample and a portion of desired size can be obtained from there.

There is also, in virtually all cases, a waste position (607). This position (607) will correspond to an ejection port where a sample (651), once tested, can be sent to a waste collection vessel (667) as opposed to back to the process stream (661). There is also typically a measurement cell position (605) which corresponds to the sample (651), and any other material, being sent to the measurement cell (701) for testing.

The remaining positions will typically be provided as a source for other materials for use in the testing. In the depicted embodiment, one of these comprises a calibration or cleaning position (609) which can serve to provide a calibration fluid (103d) for the system (100). The calibration fluid (103d) may be any material relevant for calibration of the sensor (705) and may be, for example, clean water (e.g. a zero sample) or could be a material with a specific known concentration of a target of interest.

In another embodiment, this position (609) may be used for providing a specific cleaning fluid (103d), such as, but not limited to, water or alcohol, to the system (100). This may be desirable, for example, if the sample (651) to be handled includes a material which is not easily removed from the measurement cell (701) or could stick to surfaces within the system (100). In some cases, such a cleaning material (103d) may not be needed as one of the reagents (103a), (103b), or (103c) may comprise a solvent suitable for cleaning the system (100). The cleaning composition (103d) may also be suitable for calibration in some embodiments and a sample (651) with no reagents added may also be suitable. The calibration and cleaning position (609) can also be eliminated in an embodiment and the functionality of calibration and/or cleaning can be provided by the grab sample position (603) if a calibration or cleaning fluid (103d) would be provided by a user when calibration or cleaning is desired.

The remaining positions (611), (613), and (615) will generally correspond to reagents (103a), (103b), and (103c) to be added to the sample (651) as part of testing. In the depicted embodiment there are three such reagents (103a), (103b), and (103c) which are provided in bottles (103). This is by no means required and the reagents (103a), (103b), and (103c) may be provided in different sized containers such as larger bottles, barrels, or even continuous feed lines which may be positioned separate from the system (100). Reagents (103a), (103b), and (103c) will generally be selected based on the process stream (661) being monitored and the type of testing to be performed in measurement cell (701).

In many cases, the reagents (103a), (103b), and (103c) used will be those specified in ASTM International or similar standards setting organization methods as the system (100) can be used to automate existing tests. Bottles (103) such as those depicted will typically be used when the testing process consumes a relatively small amount of reagent in each test as that way there is no need to store a large amount of reagent nearby making the system (100) more compact and less likely to be damaged. However, there is still plenty of reagent to perform a number of tests before refilling is required. Generally, the bottles (103) are designed to be refillable or replaceable quickly and may be capable of being replaced without halting operation of the system (100).

Each of the reagents (103a), (103b), and (103c) generally has its own valve position (611), (613) and (615) as shown in the depicted embodiment of FIG. 6. If more reagents are to be used, they will typically occupy more positions and often the number of needed reagents will define the total number of valve positions in the selection system (203) and rotary valve (301). Generally, as the valve (301) provides for a complete pathway for each of the reagents (103a), (103b), and (103c) one at a time, there is essentially no chance of them interacting with each other within the rotary valve (301) or from encountering a portion of the sample (651) (or a prior sample) prior to entering the measurement system (203).

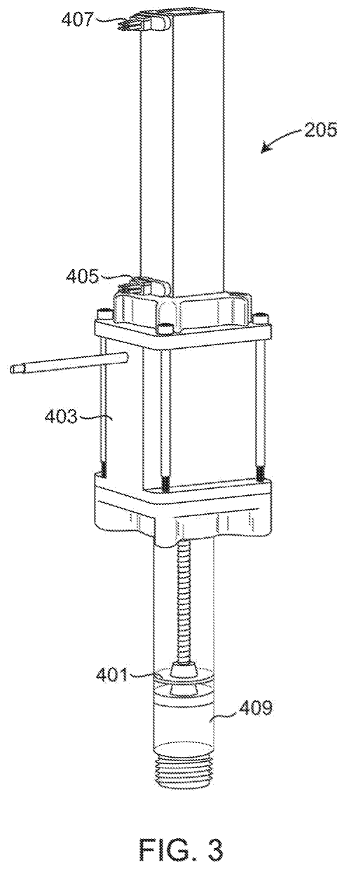

The propulsion system (205) is shown in greater detail in FIG. 3 and generally comprises a syringe pump. The pump's piston (401) will typically be located above the rotary valve (301) and within an enclosed structure (409) of the measurement system (100). The pump will typically operate by a motor (403) moving the piston (401) forward and backward. As the piston chamber (409) is typically sealed, this will create a negative pressure when the piston (401) retracts or moves upward in FIG. 3 serving to pull liquid material through whichever position (601), (603), (605), (607), (609), (611), (613), or (615) is currently open in the valve (301) and into the piston chamber (409). The valve (301) is then typically rotated to the measurement cell position (605), and pump motor (403) is typically reversed in direction to create a positive pressure and push the contents of the piston chamber (409) into the measurement cell (701).

As was the case with the motor (303) in the selection system (203), the motor (403) is preferably a stepper motor. In order to verify the position of the piston (401) and motor (403), sensors (405) and (407) may be used to verify the position of the piston (401). Having a stepper motor as both motor (303) and (403) provides for additional precision and provides for the ability to simplify reagent measurement. Specifically, as both the valve (301) position and the piston (401) movement can be readily determined, movement of the piston (401) a specific amount can be determined to bring a specific amount of a selected material very accurately.

Thus, there is no need to precisely measure the amount of material (reagent, sample, or other) as the amount can be accurately calculated based on piston (401) movement so long as the flow rate of the valve (301) is sufficient to allow the flow to complete prior to valve (301) movement. To put this another way, the combination of the steps of the motors (403) and (303) can act as a form of calculation for measurement of materials passing into the piston chamber (409). So long as fluid cannot freely flow from an open valve position into the piston chamber (409) (e.g. it must be pulled through the valve in the open position into the piston chamber (409) by the action of the piston (401)), the selected movement distance of the piston (401) combined with a clear position of the valve being either totally open or totally closed, provides for a specific amount of material to be added to the piston chamber (409).

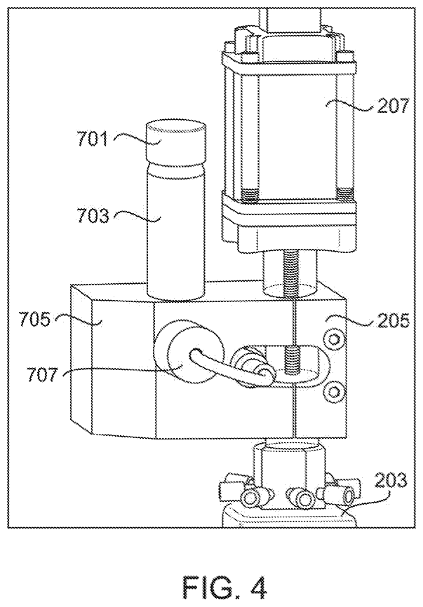

The measurement system (207) is shown in greater detail in FIG. 4 and comprises a measurement cell (701) which is where the sample (651) (along with any mixed reagent (103a), (103b), or (103c)) will be placed when the measurement occurs. The cell (701) will have functionally attached thereto a sensor (705), which is this case is a photometer (705) and an associated light source (707), capable of sensing a property of the material in the cell (701). The cell (701) is generally designed to provide access to the sample (651) in a manner which is relevant for the sensor (705) and the sensor (705) will typically be positioned in the cell (701) in a manner which allows it to act on the relevant portion of the sample (651). For example, if the sample (651) is expected to separate into two separate layers, the sensor (705) may be positioned at a point vertically on the cell (701) so as to take a reading from one or the other specific layer. The cell (701) in FIG. 4 also has functionally attached thereto a sample heater (703) which can be used to alter the temperature of the sample (651) when it is in the measurement cell (701) to assist in the measurement (such as to accelerate it) or provide for additional functionality.

In operation, the system (100) will typically operate as follows. The system (100) is generally designed to essentially perform continuous measurement of an aspect of the process stream (661) and provide a generally continuous stream of output test information. While the testing is considered generally continuous, it should be recognized that the testing does involve batch processing where a sample (651) is tested in isolation from the stream (661) and therefore is more accurately referred to as an automated fast batch testing system. In standard operation, the system (100) will operate by automatically obtaining a stream of samples (651) from the process stream (661) generally at fixed time intervals and automatically running through a testing protocol and disposing of them. This is considered continuous operation of the system (100) as it allows for continuous monitoring over time and without human intervention.

At the initiation of a test utilizing the standard sample selection, sample (651) from the associated process stream (661) is collected at position (601). However, in this embodiment, the system (100) will first run a self-cleaning cycle. This is not required, but it is preferred as it insures that no material from a prior test remains in the piston chamber (409). To run the cleaning cycle, the valves (301) will generally first be homed using the homing sensor (305). This makes sure that the rotary valve (301) is correctly calibrated and positioned. The rotary valve (301), in this embodiment, will be set to obtain a sample (651) to use as the cleaning fluid which may be where it is positioned at calibration as in the depicted embodiment. This may be using the sample position (601), the grab sample position (603), or the cleaning/calibration position (609). The former two can be used if a sample itself is used for the cleaning action as per standard lab guidelines, the latter two may be used if a specific cleaning fluid is required. If the latter is used, a specific cleaning fluid may be provided to the system by an operator via the grab sample position (603) or automatically in the cleaning/calibration position (609).

Once positioned, the piston (401) is fully retracted pulling the sample (651) or other material into the piston chamber (409) and filling the piston chamber (409). The valve (301) is then set to waste as the piston (401) is extended fully expelling the contents of the piston chamber (409) to waste. Alternatively, the sample (651) may be sent back to the process stream (661) or the sample vessel (653) supplied by a user.

This process may be repeated any number of times to continue to flush the piston chamber (409) with cleaning material as is desired. Alternatively, instead of utilizing a sample material (651) in cleaning, a cleaning material may be selected from the reagents (103a), (103b), or (103c) in bottles (103), and be pulled and exhausted from the piston chamber (409) in similar fashion. Cleaning materials may also be sent to the measurement cell (701) if cleaning of that vessel is also desired.

Once the cleaning process has completed, the rotary valve (301) is set to the sample position (601) to obtain the sample. As the piston (401) is fully extended at this position (that is where it typically is positioned after the cleaning process), the propulsion system (205) may be directed to obtain the correct volume of sample which it does by withdrawing the piston (401) the correct amount to obtain that amount of material based on the distance the piston withdrew and the expected flow through the valve (301) at position (601).

The rotary valve (301) is then moved to the position (611) of the first reagent (103a) to be added (reagent 1). The piston (401) is then withdrawn a further amount to obtain the amount of the first reagent (103a) where:

PUMP POSITION VOLUME=REAGENT 1 VOLUME+SAMPLE VOLUME.

As should be clear, forcing the two materials into the piston chamber (409) together will typically result in a mixing action and the system (100) may delay for a period of time to allow for dispersion of the two materials relative to each other. However, as the volume of reagent (103a) will often be dramatically less than the volume of sample (651), mixing may be specifically accomplished by setting the valve (301) to the measurement cell position (605), pushing the sample (651) (and also the selected amount of reagent 1 in the piston chamber (409)) to the cell (701), and then pulling it back to the piston chamber (409). In this arrangement, the high shear from the liquid movement of the two materials will generally serve to thoroughly blend the mixture. Once the mixing is considered complete, the system (100) may provide a delay to allow for settling of the mixture or for a reaction to complete.

If this is the only reagent to be added, the rotary valve (301) may be set to the measurement cell (701) and the mixture sent for testing. However, in the present embodiment, a more complicated testing procedure will be illustrated which is of a type suitable for water purification testing amongst other things. After the waiting period, the rotary valve (301) is then moved to the position (613) of the second reagent (103b) to be added (reagent 2). The piston (401) is then withdrawn a further amount to obtain the amount of the second reagent (103b) where:

PUMP POSITION VOLUME=REAGENT 2 VOLUME+REAGENT 1 VOLUME+SAMPLE VOLUME.

Again, mixing will occur and a period may be provided for mixing to complete. However, in this embodiment, the waiting is not necessary as a middle calibration test will be performed on the reagent 1, reagent 2, and sample mixture.

After reagent 2 is added, the rotary valve (301) may be set to the measurement cell position (605) and the piston (401) is moved and fully extended to send the entire contents of the piston chamber (409) to the measurement cell (701). The shearing action of the movement to the measurement cell (701) will generally promote mixing. A delay may be introduced after this if desired, such as to allow separation of the mixture into layers or to insure a reaction is complete. This period can also allow for heating or cooling of the mixture using the heater (703), if desired.

Once any delay is completed, the sensor (705) may perform a measurement on the mixture. In this embodiment, the measurement is a calibration measurement for the sensor (705) for this sample (651) and may be, for example, a calculation of light absorbance or reflectance before a marker is added. Thus, light will be provided to the mixture by light source (707) and the photometer (705) will calculate the amount of reflection detected on the raw sample (651) before addition of the marker.

Upon completion of the measurement, the valve (301) is returned to the measurement cell position (605) (it may have been placed at a different position during the testing to inhibit backflow) and the piston (401) is retracted again. This can allow for the mixture to be withdrawn back into the piston chamber (409). In an alternative embodiment, only a portion of the mixture may be withdrawn or the mixture may be left in the measurement cell (701) when reagent three (103c) is obtained in the piston chamber (409).

However, in the current embodiment it is presumed that the volume of reagent 3 is small as compared to the prior mixture volume and, therefore, it is desirable to pull reagent 3 into the prior mixture within the piston chamber (409). In this case, once the entire volume of mixture has returned to the piston chamber (409), the rotary valve is set the third reagent position (615) and the desired volume of reagent 3 (103c) is added to the mixture recognizing that:

PUMP POSITION VOLUME=REAGENT 3 VOLUME+REAGENT 2 VOLUME+REAGENT 1 VOLUME+SAMPLE VOLUME

Again, the insertion of reagent 3 will generally cause mixing and a delay may again be introduced.

Once the addition of reagent 3 is complete, the valve (301) is set the measurement cell position (605) and the piston (401) is fully extended to exhaust the entire contents of the piston chamber (409) to the measurement cell (701). This again, will cause mixing and additional delay may be introduced in the measurement cell (701) to insure a reaction completes or that the mixture settles in a desired fashion. Moving the mixture between the piston chamber (409) and the measurement cell (701) may be repeated if desired to allow for multiple measurements to be performed if there is a need to average the sensor (705) output or to ensure complete mixing.

The mixture will typically now have the actual measurement performed and a value will be recorded. The entire mixture will then typically be returned to the piston chamber (409) by opening the rotary valve (301) and retracting the piston (401), Once there, the valve (301) may be set to the waste position (607) and the piston (401) fully extended to dispose of the sample (651).

At this time, the process may repeat with the system (100) again performing a cleaning cycle and obtaining a new sample (651) as discussed above. As should be apparent, the entire testing process may be performed relatively quickly and can be repeated again immediately upon completion of a prior testing cycle making the fast batch process operate essentially continuously.

While the above provides for generally continuous operation of the system (100) on a process stream (661), the device (100) can also operate on a specific provided “one-off” sample in another form of operation. This may be done, for example, to spot check the output of the system (100) such as through the provision of a calibrated “test” sample or may be used to compare the output at one point along the process stream (661) with another using the same testing apparatus for consistency. For example, the system (100) may be positioned before a chemical is added to the process stream to remove the contaminant of interest. Thus, the output of the system (100) is to report the input percentage of the contaminant. The grab sample may be used to provide the system (100) with a test sample drawn from the process stream after the chemical has been added to verify that neutralization is occurring as intended.

In an embodiment of a grab sample operation, the system (100) may utilize the grab sample valve position (603) which is designed to allow the system (100) to take in an input as a sample which is not directly from the process stream (661) via position (601). The processing of the sample will then generally continue as discussed above, but the process will not repeat as only a single sample is designed to be obtained during this method as opposed to this being a continuous monitoring method as contemplated above. The result of such a grab sample operation may also be separately displayed.

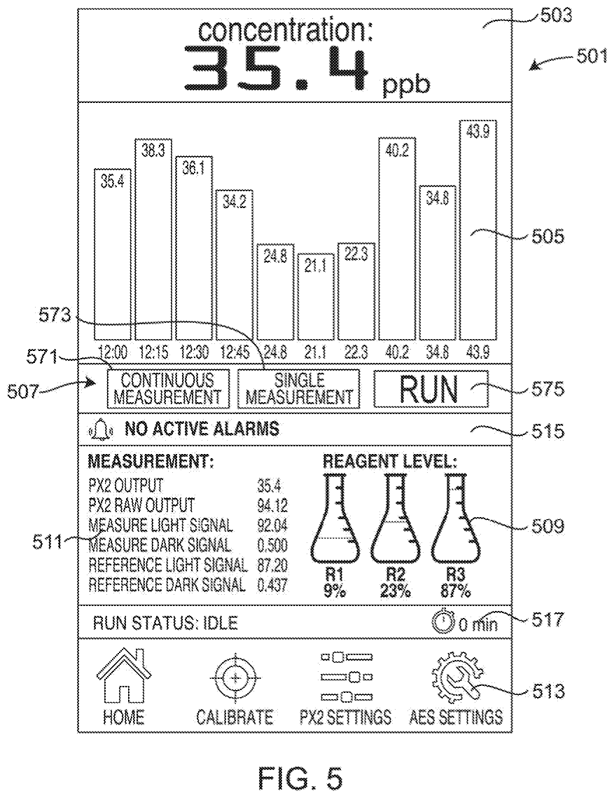

FIG. 5 shows the display (501) that may be used to operate the system (100) and to provide a display of output. The display (501) will typically display on screen (105) which may be an interactive touch screen or have other controls to allow a user to select parts of the display (501). In the embodiment of FIG. 5, the display (501) may provide a variety of useful information.

In the embodiment of FIG. 5, the system (100) is designed to detect a concentration of a particular material (a contaminant) of interest in the process stream (661). The average concentration over multiple measurements (503) of different samples (651) is first provided. In most cases, this number will be desired to be maintained within a range and is the target of the system (100). The individual values (505) which correspond to the individual samples (651) that went into the average are also displayed. In this case, they are provided on a chart to show trend information if desired. It should be recognized that each bar may actually comprise an average of multiple tests performed on the same sample (651). For example, if the same test was performed multiple times on the same sample (651) the output of those tests may be averaged to obtain the value used for a single bar in the chart (505) while the average indication (503) shows the average of all the values of all the displayed bars (across multiple different samples (651) at different times).

The buttons (507) will generally provide for the particular mode of operation. In this case, continuous operation or single sample operation as discussed above. Thus, pressing the continuous measurement button (571) will tell the system (100) to use the sample valve position (601) and draw the sample (651) from the process stream (661), while the single measurement button (573) will tell the system (100) to utilize the grab sample valve position (603) and draw the sample (651) from an external access port (663). The buttons (507) also provide a “run” button (575) which indicates when the system (100) has been activated and is triggered by the user to run the system (100). Thus, when the run button (575) is pushed, the system (100) carries out the selected measurement type and will operate until it is completed. In the continuous operation, this is typically until stopped by a user or if an alert occurs.

Below the buttons (507) there are a variety of system monitors which include the alarm indicator (515) which will indicate if the system (100) has detected a problem which may be either in its own operation or if the process stream measurement goes outside of set boundaries. There is also a monitor of the reagent level (509) which can indicate the amount of material in the various bottles (103). This may be based on known usage based on the bottle (103) size and how much has been known to have been removed and consumed by the system (100) or may be based on actual sensor measurements within a bottle (103). In the depicted embodiment, the former will generally be used as the accuracy of the usage is quite high due to the accuracy of the motors (403) and (303). When a bottle (103) reaches a certain threshold (for example 5% or 3% or 1%) of its full amount, this may trigger an alert in alert section (515). The final section of alerts simply provides calibration information (511) for the sensors. This can be useful for review in an alert situation or simply to monitor if the system (100) is running as expected.

Finally, at the very bottom of the display (501) there are menu controls. These can be used to calibrate or otherwise modify the operation of the system (100) including setting variables such as delay times and the relative quantity of the materials to mix, heating parameters, number of piston (401) cycles while mixing, etc. They can also be used to program the particular testing pattern used by the system (100) and to calibrate the photometer (705). The display (501) also includes at the bottom a run status indicator (517) which typically is used simply to indicate if the system (100) is currently operating or not and will generally be most valuable to make sure that the system (100) is currently operating in its continuous mode if that had been previously selected.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “orthogonal” are purely geometric constructs and no real-world component or relationship is truly “orthogonal” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A testing system comprising:
a rotary valve comprising a plurality of valve positions;
a process stream having a sample collection apparatus therein, the sample collection apparatus being located at a first position in the plurality of valve positions;
a measurement cell, the measurement cell being located at a second position in the plurality of valve positions;
a motor, for rotating the rotary valve between the plurality of positions;
a piston, for directing material through the rotary valve;
a sensor, for performing a measurement on a sample in the measurement cell.

2. The testing system of claim 1 wherein the motor comprises a stepper motor.

3. The testing system of claim 1 wherein the sensor comprises a photometer and associated light source.

4. The testing system of claim 1 further comprising reagent in a reagent bottle connected to a third position in the plurality of valve positions.

5. The testing system of claim 4 wherein the piston obtains the sample from the sample collection apparatus and then obtains the reagent from the reagent bottle before providing both the reagent and the sample to the measurement cell.

6. The testing system of claim 5 wherein providing the reagent and the sample to the measurement cell mixes the reagent with the sample to form a mixture.

7. The testing system of claim 6 wherein after the sensor performs the measurement on the mixture, the piston obtains the mixture from the measurement cell.

8. The testing system of claim 7 wherein the piston exhausts the mixture to a waste collection vessel attached to a fourth position in the plurality of valve positions.

9. The testing system of claim 1 further comprising a port for attaching a sample container at a third position in the plurality of positions.

10. The testing system of claim 1 further comprising calibration fluid in a calibration fluid bottle at a third position in the plurality of positions.

11. The testing system of claim 1 further comprising a cleaning fluid in a cleaning fluid bottle at a third position in the plurality of positions.

12. The testing system of claim 1 further comprising multiple reagents, each of the reagents being in a separate reagent bottle connected to a separate position in the plurality of positions.

13. The testing system of claim 1 further comprising a homing sensor for detecting when the rotary valve is at a specific position in the plurality of positions.

14. The testing system of claim 13 wherein the specific position is the first position.

15. A method of performing automated testing, the method comprising:
providing a testing system comprising:
a rotary valve comprising a plurality of valve positions;
a process stream having a sample collection apparatus therein, the sample collection apparatus being located at a first position in the plurality of valve positions;
a measurement cell including an associated sensor, the measurement cell being located at a second position in the plurality of valve positions; and
a reagent located at a third position in the plurality of valve positions;
automatically rotating the rotary valve to the first position and obtaining a sample;
automatically rotating the rotary valve to the third position and obtaining a reagent that is mixed with the sample to form a mixture;
automatically rotating the rotary valve to the second position and exhausting the mixture to the measurement cell;
using the sensor to perform a measurement on the mixture;
returning the mixture from the measurement cell; and
automatically rotating the rotary valve to a fourth position and disposing of the mixture.

16. The method of claim 15 wherein the sensor comprises a photometer and associated light source.

17. The method claim 15 wherein the reagent and the sample are mixed via shear of drawing the reagent into the sample.

18. The method of claim 17 wherein the mixture if further mixed by shear of exhausting the mixture to the measurement cell.
